(19) United States
(12) Patent Application Publication
(10) Pub. No.: US 2012/0208734 A1
(43) Pub. Date: Aug. 16, 2012

(54) LIQUID DISHWASHER DETERGENT

(75) Inventors: Thomas Eiting, Dusseldorf (DE); Dorota Sendor-Müller, Dusseldorf (DE); Johannes Zipfel, Dusseldorf (DE); Arnd Kessler, Monheim am Rhein (DE); Thorsten Bastigkeit, Wuppertal (DE); Christian Nitsch, Dusseldorf (DE); Seven Müller, Duisburg (DE); Konstantin Benda, Dusseldorf (DE)

(73) Assignee: Henkel AG & Co. KGaA, Dusseldorf (DE)

(21) Appl. No.: 13/456,544

(22) Filed: Apr. 26, 2012

Related U.S. Application Data
(63) Continuation of application No. PCT/EP2010/066421, filed on Oct. 29, 2010.

(30) Foreign Application Priority Data
Oct. 30, 2009 (DE) 10 2009 046 217.1

(51) Int. Cl. C11D 3/386

(52) U.S. Cl. 510/221

(57) ABSTRACT

The invention relates to dishwasher detergents, comprising a packaging means and two liquid washing or cleaning agents A and B, which are present in said packaging means separate from each other and which have the following composition: A: −10 to 55 wt. % builder(s); −0.1 to 15 wt. % enzyme(s); −0.001 to 30 wt. % bleach activator; −20 to 70 wt. % water; and B: −50 to 99.9 wt. % water; −0.1 to 50 wt. % oxygen bleaching agent, −<20 wt. % further ingredients, characterized in that the liquid cleaning agents A and B have a pH value (20° C.) of less than 9. The dishwasher detergents are characterized by good cleaning power when dishes are washed in the dishwasher.

### CROSS-REFERENCES TO RELATED APPLICATIONS

This application is a continuation of PCT/EP2010/066421, filed on Oct. 29, 2010, which claims priority under 35 U.S.C. §119 to DE 10 2009 046 217.1 filed on Oct. 30, 2009, both of which are hereby incorporated by reference.

### FIELD OF THE INVENTION

The present invention generally relates to automatic dishwasher detergents that comprise bleaching agent as well as dishwashing processes involving the use of these dishwasher detergents.

### BACKGROUND OF THE INVENTION

More stringent standards are often posed for machine-washed tableware than for hand-washed tableware. Thus, tableware that at first glance is completely free of food residues is not considered to be impeccable if after the automatic dishwashing process the tableware still has discolorations on its surface, resulting for example from the deposition of vegetal dyes.

Bleaching agents are used in automatic dishwasher detergents in order that spotless tableware may be obtained. To activate these bleaching agents and in order to obtain an improved bleaching effect when cleaning at temperatures of 60° C. and below, the automatic dishwasher detergents generally further comprise bleach activators or bleach catalysts, wherein the bleach catalysts in particular have proved to be particularly effective.

Limitations to the use of these bleaching agents are set due to incompatibilities with other active washing and cleaning ingredients, such as for example enzymes, or due to problems of stability during storage of washing or cleaning agents that comprise bleaching agents. This also applies in particular to liquid washing or cleaning agents.

A technical possibility to improve the cleaning power of automatic dishwasher detergents consists in increasing the alkalinity of these detergents. However, whereas on the one hand the cleaning power of automatic dishwasher detergents increases with increasing alkalinity, on the other hand strongly alkaline cleaners also cause damage to the silicate structure of glasses and can cause severe irritation on skin contact.

The alkali metal phosphates have proved to be particularly effective builders for increasing the alkalinity and for this reason form the main constituent of the predominant number of commercially available automatic dishwasher detergents.

Although the phosphates, due to their advantageous action, are very much appreciated as an ingredient of automatic dishwasher detergents, their use, however, is not unproblematic from the point of view of environmental protection, as a considerable part of the phosphate reaches open water through domestic waste water and plays a critical role in their eutrophication, particularly in still waters (lakes, dams). As a consequence of this phenomenon, also known as eutrophication, the use of pentasodium triphosphate in fabric washing agents was considerably reduced in several countries (e.g. USA, Canada, Italy, Sweden, Norway) by means of statutory provisions and totally banned in Switzerland. In Germany since 1984, washing agents may still comprise up to 20% of this builder.

Consequently, a limitation of the alkalinity and of the phosphate content in automatic dishwasher detergents is desirable both from the point of view of the consumer as well as in regard to a sustainable product development.

Accordingly, it is desirable to provide a cleaning agent for dishwashing which, compared with conventional dishwasher detergents, is characterized by an improved cleaning power even at low temperature cleaning cycles or in low-consumption water cleaning cycles. In particular, the dishwasher detergent should exhibit a good cleaning power in spite of a lower alkalinity, wherein for example an improved cleaning power for bleachable stains would be preferred, without causing increased damage to glass or ceramic surfaces.

It was surprisingly found that the abovementioned object can be achieved by a low alkaline automatic dishwasher detergent.

Furthermore, other desirable features and characteristics of the present invention will become apparent from the subsequent detailed description of the invention and the appended claims, taken in conjunction with the accompanying drawings and this

### BRIEF SUMMARY OF THE INVENTION

An automatic dishwasher detergent, including a packaging means, in which are located two separately packaged liquid cleaning agents A and B of the composition: A: 10 to 55 wt % builder(s), 0.1 to 15 wt % enzyme preparation(s), 0.001 to 30 wt % bleach activator, 20 to 70 wt % water, and B: 50 to 99.9 wt % water, 0.1 to 50 wt % oxygen bleaching agent, <20 wt % of other ingredients wherein the liquid cleaning agents A and B exhibit a pH (20° C.) below 9.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A first subject matter of this application is an automatic dishwasher detergent, including a packaging means, in which are located two separately packaged liquid automatic cleaning agents A and B of the composition:

A: −10 to 55 wt % builder(s);
−0.1 to 15 wt % enzyme preparation(s);
−0.001 to 30 wt % bleach activator
−20 to 70 wt % water; and

B: −50 to 99.9 wt % water;
−0.1 to 50 wt % oxygen bleaching agent
−<20 wt % of other ingredients
   wherein the liquid cleaning agents A and B exhibit a pH (20° C.) below 9.

The inventive automatic dishwasher detergents are liquid. The automatic cleaning agents A and B comprise water as the essential solvent. The water content of the dishwasher detergent A, relative to its total weight, is between 20 and 70 wt %, preferably between 25 and 60 wt % and especially between 30 and 50 wt %. In the dishwasher detergent B the water content, relative to the total weight of the dishwasher detergent B, is 50 to 99.9 wt %, advantageously between 70 and 99 wt %, preferably between 80 and 98 wt %.

Adding water to the automatic dishwasher detergents A and B not only facilitates their metering, but in addition the water content accelerates the release of the active cleaning ingredients into the cleaning liquor.

The term water content includes the total amount of water comprised in the inventive agents which is from the free water comprised in the composition of the agents as well as from the water in bound form incorporated through the active washing and cleaning agents into the cleaning agent preparations. The water content can be determined for example as the loss on drying or according to Karl Fischer.

The inventive automatic dishwasher detergents are slightly alkaline. Preferred automatic dishwasher detergents are those wherein the washing or cleaning agent A exhibits a pH value (20° C.) between 6.5 and 8.5, preferably between 7 and 8. The pH (20° C.) of the automatic cleaning agent B is advantageously between 4.0 and 7.0, preferably between 5.0 and 6.0. The pH values (20° C.) of the automatic dishwasher detergents advantageously differ by preferably not more than 3.0 units, preferably by not more than 2.0 units.

The inventive agents possess a very good cleaning power in spite of their low alkalinity. This is all the more surprising, as an alkaline cleaning liquor is considered as an essential basis for the cleaning performance in automatic dishwashing processes.

In spite of their significantly reduced alkalinity in comparison with conventional automatic dishwasher detergents, the inventive dishwasher detergents comprise builders as one of their essential ingredients. These builders advantageously make up more than 50 wt %, preferably more than 70 wt % and especially more than 90 wt % of the ingredients of the cleaning agent A.

The preferred builders include particularly the calcium-complexing builders from the group of the phosphates and/or of the phosphonates. Active cleaning polymers, for example sulfonic acid group-containing polymers, can be added to supplement these builders.

The alkali metal phosphates are the most important among the large number of the commercially available phosphates in the washing and cleaning industry. “Alkali metal phosphates” is the collective term for the alkali metal (more particularly sodium and potassium) salts of the various phosphoric acids, in which metaphosphoric acids (HPO₃)ₙ and orthophosphoric acid (H₃PO₄) and representatives of higher molecular weight can be differentiated. The phosphates combine several inherent advantages: They act as alkalinity sources, prevent lime deposits on machine parts and lime incrustations in fabrics and, in addition, contribute towards the cleansing power.

Inventively particularly preferred phosphates are the pentasodium triphosphate, Na₅P₃O₁₀ (sodium tripolyphosphate) as well as the corresponding potassium salt pentapotassium triphosphate K₅P₃O₁₀ (potassium tripolyphosphate). According to the invention, the sodium potassium tripolyphosphates are again preferably employed.

In the context of the present application, if phosphates are incorporated as the active cleaning substances in the automatic dishwasher detergents, then preferred compositions comprise this/these phosphate(s), preferably alkali metal phosphate(s), particularly preferably pentasodium or pentapotassium triphosphate, especially pentapotassium triphosphate, in quantities of 5 to 40 wt %, preferably 7 to 35 wt % and especially 10 to 30 wt %, each based on the weight of the automatic dishwasher detergent A.

Besides the 1-hydroxyethane-1,1-diphosphonic acid, the phosphonate complexants include a series of different compounds such as for example diethylenetriamine penta (methylene phosphonic acid) (DTPMP). Hydroxyalkane phosphonates or aminoalkane phosphonates are particularly preferred in this application. Among the hydroxyalkane phosphonates, 1-hydroxyethane-1,1-diphosphonate (HEDP) is of particular importance as the cobuilder. It is normally added as the sodium salt, the disodium salt reacting neutral and the tetrasodium salt reacting alkaline (pH 9). Ethylenediamine tetramethylene phosphonate (EDTMP), diethylenetriamine pentamethylene phosphonate (DTPMP) and their higher homologs are preferably chosen as the aminoalkane phosphonates. They are preferably added in the form of the neutral-reacting sodium salts, e.g. as the hexasodium salt of EDTMP or as the hepta and octasodium salt of DTPMP. Of the class of phosphonates, HEDP is preferably used as the builder. The aminoalkane phosphonates additionally possess a pronounced ability to complex heavy metals. Accordingly, it can be preferred, particularly where the agents also contain bleach, to use aminoalkane phosphonates, particularly DTPMP, or mixtures of the cited phosphonates.

In the context of this application, a preferred automatic dishwasher detergent comprises one or more phosphonate(s) from the group
a) aminotrimethylene phosphonic acid (ATMP) and/or salts thereof;
b) ethylenediamine tetra(methylene phosphonic acid) (EDTMP) and/or salts thereof;
c) diethylenetriamine penta(methylene phosphonic acid) (DTPMP) and/or salts thereof;
d) 1-hydroxyethane-1,1-diphosphonic acid (HEDP) and/or salts thereof;
e) 2-phosphonobutane-1,2,4-tricarboxylic acid (PBTC) and/or salts thereof;
f) hexamethylenediamine tetra(methylene phosphonic acid) (HDTMP) and/or salts thereof;
g) nitrilotri(methylene phosphonic acid) (NTMP) and/or salts thereof.

Particularly preferred automatic dishwasher detergents comprise 1-hydroxyethane-1,1-diphosphonic acid (HEDP) or diethylenetriamine penta (methylene phosphonic acid) (DTMP) as the phosphonates. The weight fraction of the phosphonates in the total weight of the inventive automatic cleaning agent preparations A is advantageously 0.8 to 12 wt %, preferably 1.0 to 10 wt % and especially 1.2 to 8 wt %. The cleaning power of the inventive automatic dishwasher detergents could be improved by adding phosphonates to the cleaning agent A.

Further preferred builders are, for example the polycarboxylic acids that can be used in the form of the free acid and/or their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, amino carboxylic acids, nitrilotriacetic acid (NTA), providing such use is not ecologically unsafe, and mixtures thereof. Besides their building effect, the free acids also typically have the property of an acidifying component and hence also serve to establish a relatively low and mild pH of washing or cleaning agents. Citric acid, succinic acid, glutaric acid, adipic acid, gluconic acid and any mixtures thereof are particularly mentioned in this regard.

Particularly preferred inventive cleaning agents A comprise citrate as one of their essential builders. However, it is also conceivable to add methylglycine diacetic acid.

The cleaning agent A and also the cleaning agent B can comprise active cleaning polymers to supplement the above described builders. The weight fraction of the active cleaning polymers in the total weight of the inventive automatic cleaning agent preparations A is advantageously 0.1 to 20 wt %, preferably 1.0 to 15 wt % and especially 2.0 to 12 wt %.

Sulfonic acid group-containing polymers, in particular from the group of the copolymeric polysulfonates, are preferably added as the active cleaning polymers. These copolymeric polysulfonates comprise, in addition to sulfonic acid group-containing monomer(s), at least one monomer from the group of the unsaturated carboxylic acids.

Particularly preferred unsaturated carboxylic acids are unsaturated carboxylic acids of the formula R¹(R²)C═C(R³)COOH, in which R¹ to R³ independently of one another stand for —H, —CH₃, a linear or branched, saturated alkyl group containing 2 to 12 carbon atoms, a linear or branched, mono or polyunsaturated alkenyl group containing 2 to 12 carbon atoms, alkyl or alkenyl groups substituted by —NH₂, —OH or —COOH as defined above or for —COOH or —COOR⁴, wherein R⁴ is a saturated or unsaturated, linear or branched hydrocarbon group containing 1 to 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic acid anhydride, fumaric acid, itaconic acid, citraconic acid, methylenemalonic acid, sorbic acid, cinnamic acid or their mixtures. Of course, the unsaturated dicarboxylic acids can also be added.

The preferred monomers containing sulfonic acid groups are those of the formula

R⁵(R⁶)C═C(R⁷)—X—SO₃H

in which R⁵ to R⁷ independently of one another stand for —H, —CH₃, a linear or branched, saturated alkyl group containing 2 to 12 carbon atoms, a linear or branched, mono or polyunsaturated alkenyl group containing 2 to 12 carbon atoms, with —NH₂, —OH or —COOH substituted alkyl or alkenyl groups or for —COOH or —COOR⁴, wherein R⁴ is a saturated or unsaturated, linear or branched hydrocarbon group containing 1 to 12 carbon atoms, and X stands for an optionally present spacer group that is selected from —(CH₂)ₙ— with n=0 to 4, —COO—(CH₂)ₖ— with k=1 to 6, —C(O)—NH—C(CH₃)₂—, —C(O)—NH—C(CH₃)₂CH₂— and —C(O)—NH—CH(CH₂CH₃)—.

Among these monomers those are preferred of the formulas

H₂C═CH—X—SO₃H

H₂C═C(CH₃)—X—SO₃H

HO₃S—X—(R⁶)C═C(R⁷)—X—SO₃H,

in which R⁶ and R⁷ independently of one another are selected from —H, —CH₃, —CH₂CH₃, —CH₂CH₂CH₃, —CH(CH₃)₂ and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Accordingly, particularly preferred sulfonic acid group-containing monomers are 1-acrylamido-1-propane sulfonic acid, 2-acrylamido-2-propane sulfonic acid, 2-acrylamido-2-methyl-1-propane sulfonic acid, 2-methacrylamido-2-methyl-1-propane sulfonic acid, 3-methacrylamido-2-hydroxypropane sulfonic acid, allyl sulfonic acid, methallyl sulfonic acid, allyloxybenzene sulfonic acid, methallyloxybenzene sulfonic acid, 2-hydroxy-3-(2-propenyloxy)propane sulfonic acid, 2-methyl-2-propene-1-sulfonic acid, styrene sulfonic acid, vinyl sulfonic acid, 3-sulfopropyl acrylate, 3-sulfopropyl methacrylate, sulfomethacrylamide, sulfomethylmethacrylamide and mixtures of the cited acids or of their water-soluble salts.

The sulfonic acid groups in the polymers can be completely or partially in neutralized form. The addition of copolymers containing partly or fully neutralized sulfonic acid groups is preferred according to the invention.

The molecular weight of the inventively preferred sulfo-copolymers used can be varied to adapt the properties of the polymer to the desired application requirement. Preferred automatic dishwasher detergents are characterized in that the copolymers have molecular weights from 2000 to 200 000 gmol⁻¹, preferably 4000 to 25 000 gmol⁻¹ and especially 5000 to 15 000 mol⁻¹.

In another preferred embodiment, the copolymers, beside the carboxylic acid group-containing monomer and the sulfonic acid group-containing monomer, additionally contain at least one non-ionic, preferably hydrophobic monomer. In particular, the rinsing performance of the inventive automatic dishwasher detergent can be improved by the addition of these hydrophobically modified polymers.

Inventively preferred automatic dishwasher detergents are those wherein the cleaning agent A comprises a copolymer, containing

i) monomer(s) containing carboxylic acid groups

ii) monomers containing sulfonic acid groups

iii) non-ionic monomer(s).

By adding these terpolymers, the rinsing performance of the inventive automatic dishwasher detergents could be improved compared with comparable dishwasher detergents that comprise sulfo-polymers without added non-ionic monomers.

Preferably, monomers of the general formula R1(R²)C═C(R³)—X—R⁴ are added as the non-ionic monomers, in which R¹ to R³ independently of one another stands for —H, —CH₃ or —C₂H₅, X stands for an optionally present spacer group selected from —CH₂—, —C(O)O— and —C(O)—NH—, and R⁴ stands for a straight chain or branched saturated alkyl group containing 2 to 22 carbon atoms or for an unsaturated, preferably aromatic group containing 6 to 22 carbon atoms.

Particularly preferred non-ionic monomers are butene, isobutene, pentene, 3-methylbutene, 2-methylbutene, cyclopentene, hexene, 1-hexene, 2-methlypentene-1, 3-methylpentene-1, cyclohexene, methylcyclopentene, cycloheptene, methylcyclohexene, 2,4,4-trimethylpentene-1, 2,4,4-trimethylpentene-2, 2,3 -dimethylhexene-1, 2,4-dimethylhexene-1, 2,5-dimethlyhexene-1, 3,5-dimethylhexene-1, 4,4-dimethylhexene-1, ethylcyclohexyne, 1-octene, α-olefins containing 10 or more carbon atoms such as for example 1-decene, 1-dodecene, 1-hexadecene, 1-octadecene and C₂₂-α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, methyl acrylate, ethyl acrylate, propyl acrylate, butyl acrylate, pentyl acrylate, hexyl acrylate, methyl methacrylate, N-(methyl)acrylamide, 2-ethylhexyl acrylate, 2-ethylhexyl methacrylate, N-(2-ethylhexyl)acrylamide, octyl acrylate, octyl methacrylate, N-(octyl)acrylamide, lauryl acrylate, lauryl methacrylate, N-(lauryl)acrylamide, stearyl acrylate, stearyl methacrylate, N-(stearyl)acrylamide, behenyl acrylate, behenyl methacrylate and N-(behenyl)acrylamide or their mixtures.

The weight fraction of the sulfonic acid group-containing copolymers in the total weight of the inventive automatic cleaning agent A is advantageously 0.1 to 15 wt %, preferably 1.0 to 12 wt % and especially 2.0 to 10 wt %.

In summary, preferred automatic dishwasher detergents are those wherein the cleaning agent A comprises calcium-complexing builders from the group of the phosphates, the phosphonates, the citrates and/or the sulfonic acid group-containing polymers, preferably in amounts of 10 to 45 wt %, preferably 15 to 40 wt % and particularly 20 to 30 wt %, each relative to the total weight of the cleaning agent A.

The compositions of some preferred inventive automatic dishwasher detergents can be found in the following Table:

TABLE 1

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Potassium | 5.0 to 40 | 5.0 to 40 | 7.0 to 35 | 10 to 30 |
| tripolyphosphate | | | | |
| Phosphonate | 0.8 to 12 | 0.8 to 12 | 1.0 to 10 | 1.2 to 8.0 |
| Sulfopolymer¹ | 0.1 to 15 | 0.1 to 15 | 1.0 to 12 | 2.0 to 10 |
| Enzyme preparation | 0.2 to 12 | 0.2 to 12 | 0.5 to 10 | 2.0 to 8.0 |
| Bleach activator | 0.01 to 30 | 0.01 to 25 | 0.01 to 20 | 0.01 to 15 |
| Water | 20 to 70 | 22 to 60 | 24 to 55 | 26 to 50 |

Cleaning agent B; pH (20° C.) 4.0 to 7.0

| | | | | |
|---|---|---|---|---|
| Oxygen bleaching agent | 0.2 to 40 | 1.0 to 30 | 1.0 to 30 | 2.0 to 20 |
| Water | 50 to 99 | 60 to 98 | 60 to 98 | 70 to 97 |

¹Copolymer, containing i) carboxylic acid group-containing monomer(s), sulfonic acid group-containing monomer(s) and non-ionic monomer(s)

The inventive automatic dishwasher detergents comprise enzymes as a second essential ingredient. These enzymes are preferably exclusively comprised in the cleaning agent A.

The cleaning agents A comprise at least one active cleaning enzyme preparation as a further essential ingredient. The weight fraction of the active cleaning enzyme preparation(s) in the total weight of the cleaning agent A is between 0.1 and 15 wt %, preferably between 0.2 and 12 wt %, particularly preferably between 0.5 and 10 wt % and especially between 2.0 and 8.0 wt %.

An enhanced cleaning effect was observed to a particular degree with the amylases, the proteases and the lipases, which is why inventive liquid cleaning agents A preferably comprise enzymes from the group of the amylases, proteases and/or lipases. However, hemicellulases, cellulases, perhydrolases or oxidoreductases, for example, can also be used. In principle, the mentioned enzymes are of natural origin; improved variants based on the natural molecules are available for use in washing or cleaning agents and accordingly they are preferably employed. The washing or cleaning agents preferably comprise enzymes in total quantities of 1×10⁻⁶ to 5 wt % based on active protein. The protein concentration can be determined using known methods, for example the BCA process or the biuret process.

Preferred proteases are those of the subtilisin type. Examples of these are the subtilisins BPN′ and Carlsberg as well as their further developed forms, the protease PB92, the subtilisins 147 and 309, the alkaline protease from Bacillus lentus, subtilisin DY and those enzymes of the subtilases, no longer however classified in the stricter sense as subtilisins: thermitase, proteinase K and the proteases TW3 and TW7.

Examples of inventably useable amylases are the a-amylases from Bacillus licheniformis, from B. amyloliquefaciens, from B. stearothermophilus, from Aspergillus niger and A. oryzae as well as their improved further developments for use in washing and cleaning agents. Moreover, for this purpose, attention should be drawn to the α-amylase from Bacillus sp. A 7-7 (DSM 12368) and the cyclodextrin-glucanotransferase (CGTase) from B. agaradherens (DSM 9948).

According to the invention, lipases can also be incorporated, particularly due to their triglyceride cleaving activities, but also in order to produce in situ peracids from suitable precursors. These include for example the available or further developed lipases originating from Humicola lanuginosa (Thermomyces lanuginosus), particularly those with the amino acid substitution D96L.

Active washing or cleaning proteases, amylases and lipases are generally not made available in the form of the pure protein but rather in the form of stabilized, storable and transportable preparations. These prefabricated preparations include, for example, solid preparations obtained by granulation, extrusion or lyophilization, or particularly for liquid compositions or gel-type compositions, enzyme solutions, advantageously as highly concentrated as possible, of low moisture content and/or mixed with stabilizers or further adjuvants.

As the preceding embodiments demonstrate, the enzyme protein forms only a fraction of the total weight of customary enzyme preparations. Inventively preferred added protease and amylase and lipase preparations comprise between 0.1 and 40 wt %, preferably between 0.2 and 30 wt %, particularly preferably between 0.4 and 20 wt % and especially between 0.8 and 10 wt % of the enzyme protein.

The cleaning agent A preferably comprises a plurality of enzymes and/or enzyme preparations, preferably liquid protease preparations and/or amylase preparations and/or lipase preparations.

The compositions of some preferred inventive automatic dishwasher detergents can be found in the following Tables:

TABLE 2

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Builder | 10 to 55 | 10 to 45 | 15 to 40 | 20 to 30 |
| Enzyme preparation² | 0.2 to 12 | 0.2 to 12 | 0.5 to 10 | 2.0 to 8.0 |
| Bleach activator | 0.01 to 30 | 0.01 to 25 | 0.01 to 20 | 0.01 to 15 |
| Water | 20 to 70 | 22 to 60 | 24 to 55 | 26 to 50 |

Cleaning agent B; pH (20° C.) 4.0 to 7.0

| | | | | |
|---|---|---|---|---|
| Oxygen bleaching agent | 0.2 to 40 | 1.0 to 30 | 1.0 to 30 | 2.0 to 20 |
| Water | 50 to 99 | 60 to 98 | 60 to 98 | 70 to 97 |

TABLE 3

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Potassium | 5.0 to 40 | 5.0 to 40 | 7.0 to 35 | 10 to 30 |
| tripolyphosphate | | | | |
| Phosphonate | 0.8 to 12 | 0.8 to 12 | 1.0 to 10 | 1.2 to 8.0 |
| Sulfopolymer¹ | 0.1 to 15 | 0.1 to 15 | 1.0 to 12 | 2.0 to 10 |
| Enzyme preparation² | 0.2 to 12 | 0.2 to 12 | 0.5 to 10 | 2.0 to 8.0 |
| Bleach activator | 0.01 to 30 | 0.01 to 25 | 0.01 to 20 | 0.01 to 15 |
| Water | 20 to 70 | 22 to 60 | 24 to 55 | 26 to 50 |

Cleaning agent B; pH (20° C.) 4.0 to 7.0

| | | | | |
|---|---|---|---|---|
| Oxygen bleaching agent | 0.2 to 40 | 1.0 to 30 | 1.0 to 30 | 2.0 to 20 |
| Water | 50 to 99 | 60 to 98 | 60 to 98 | 70 to 97 |

¹Copolymer, containing i) carboxylic acid group-containing monomer(s), sulfonic acid group-containing monomer(s) and non-ionic monomer(s) ²Amylase, protease or amylase, protease and lipase

The cleaning agents A comprise, in addition to the solvent water, 0.001 to 30 wt % bleach activator as the third essential ingredient.

The preferred usable bleach activators can be classified into different substance groups. A first group includes the bleach boosting transition metal salts or transition metal complexes such as for example salen or carbonyl complexes of Mn, Fe, Co, Ru or Mo. Manganese, iron, cobalt, ruthenium, molybdenum, titanium, vanadium and copper complexes with nitrogen-containing tripod ligands, as well as cobalt-, iron-, copper- and ruthenium-ammine complexes may also be employed as the bleach catalysts.

Automatic dishwasher detergents, wherein the cleaning agent A comprises bleach activator from the group of the transition metal catalysts, preferably from the group of the transition metal catalysts of manganese, preferably in amounts of 0.01 to 3.0 wt %, preferably 0.01 to 2.0 wt % and particularly 0.01 to 1.0 wt %, each relative to the total weight of the cleaning agent A, are inventively preferred.

Complexes of manganese in the valence state II, III, IV or V which preferably comprise one or a plurality of macrocyclic ligands with the donor functions N, NR, PR, O and/or S are particularly preferably comprised. Ligands having nitrogen donor functions are preferably employed. In this regard, it is particularly preferred to incorporate bleach catalysts into the compositions according to the invention, which comprise 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me/TACN) as the macromolecular ligands. Suitable manganese complexes are for example [Mn^{III}₂(μ-O)₁(μ-OAc)₂(TACN)₂](CIO₄)₂, [Mn^{III}Mn^{IV}(μ-O)₂(μ-OAc)1(TACN)2](BPh₄)₂, [Mn^{IV}₄(μ-O)₆(TACN)₄](CIO₄)₄, [Mn^{III}₂(μ-O)₁(μ-OAc)₂(Me-TACN)₂](CIO₄)₂, [Mn^{III}Mn^{IV}(μ-O)₁(μ-OAc)₂(Me-TACN)₂](CIO₄)₃, [Mn^{IV}₂(μ-O)₃(Me-TACN)₂](PF₆)₂ and [Mn^{IV}₂(μ-O)₃(Me/Me-TACN)₂](PF₆)₂ (OAc═OC(O)CH₃).

Automatic dishwasher detergents comprising a bleach catalyst selected from the group of the bleach boosting transition metal salts and transition metal complexes, preferably from the group of the complexes of manganese with 1,4,7-trimethyl-1,4,7-triazacyclononane (Me₃-TACN) or 1,2,4,7-tetramethyl-1,4,7-triazacyclononane (Me₄-TACN), are inventively particularly preferred as these cited bleach catalysts particularly contribute to a significantly improved cleaning result.

In another preferred embodiment, the bleach boosting transition metal complex compound corresponds to the general Formula (II),

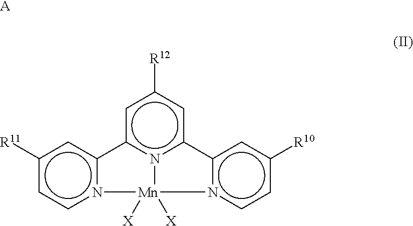

in which R¹⁰ and R¹¹ independently of one another stand for hydrogen, a C₁₋₁₈ alkyl group, a group —NR¹³R¹⁴, a group —N⁺R¹³R¹⁴R¹⁵ or a group

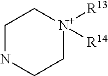

R¹² stands for hydrogen, —OH, or a C₁₋₁₈ alkyl group, R¹³, R¹⁴ and R¹⁵ independently of each other for hydrogen, a C₁₋₄ alkyl or hydroxyalkyl group and X for a halogen as well as A stands for a charge equalizing anionic ligand that depending on its charge and the nature and number of the other charges, in particular the charge of the central Manganese atom, can also be absent or exist in the plural. Manganese therein can possess, as in the complexes of the Formula (I), the valence states II, III, IV or V. If desired, but also less preferred, other transition metals, such as for example Fe, Co, Ni, V, Ru, Ti, Mo, W, Cu and/or Cr, can also be present instead of the Mn central atom in these types of complex compounds.

In a particular inventive embodiment, it is not the finished bleach boosting transition metal complex is employed as the bleach activator, rather one or more ligands are separately employed that can form, together with a transition metal, in the washing process a bleach boosting transition metal complex in situ, and the transition metal is likewise metered in separately in the form of a salt or non-bleach boosting complex, or it is brought into the cleaning process as an ingredient of the process water added for this purpose.

The compositions of some preferred inventive automatic dishwasher detergents can be found in the following Table:

TABLE 4

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Builder | 10 to 55 | 10 to 45 | 15 to 40 | 20 to 30 |
| Enzyme preparation² | 0.2 to 12 | 0.2 to 12 | 0.5 to 10 | 2.0 to 8.0 |
| Bleach activator³ | 0.01 to 3.0 | 0.01 to 2.5 | 0.01 to 2.0 | 0.01 to 1.5 |
| Water | 20 to 70 | 22 to 60 | 24 to 55 | 26 to 50 |

Cleaning agent B; pH (20° C.) 4.0 to 7.0

| | | | | |
|---|---|---|---|---|
| Oxygen bleaching agent | 0.2 to 40 | 1.0 to 30 | 1.0 to 30 | 2.0 to 20 |
| Water | 50 to 99 | 60 to 98 | 60 to 98 | 70 to 97 |

TABLE 5

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Potassium | 5.0 to 40 | 5.0 to 40 | 7.0 to 35 | 10 to 30 |
| tripolyphosphate | | | | |
| Phosphonate | 0.8 to 12 | 0.8 to 12 | 1.0 to 10 | 1.2 to 8.0 |
| Sulfopolymer¹ | 0.1 to 15 | 0.1 to 15 | 1.0 to 12 | 2.0 to 10 |
| Enzyme preparation² | 0.2 to 12 | 0.2 to 12 | 0.5 to 10 | 2.0 to 8.0 |
| Bleach activator³ | 0.01 to 30 | 0.01 to 25 | 0.01 to 20 | 0.01 to 15 |
| Water | 20 to 70 | 22 to 60 | 24 to 55 | 26 to 50 |

Cleaning agent B; pH (20° C.) 4.0 to 7.0

| | | | | |
|---|---|---|---|---|
| Oxygen bleaching agent | 0.2 to 40 | 1.0 to 30 | 1.0 to 30 | 2.0 to 20 |
| Water | 50 to 99 | 60 to 98 | 60 to 98 | 70 to 97 |

¹Copolymer, containing i) carboxylic acid group-containing monomer(s), sulfonic acid group-containing monomer(s) and non-ionic monomer(s)
²Amylase, protease or amylase, protease and lipase
³Transition metal catalyst of manganese

A second group of inventively preferred bleach activators includes the organic bleach activators and here in particular bleach activators from the group tetracetylenediamine, acetyl triethylcitrate, N-acetyl-caprolactam, N-benzoylcaprolactam and 4-morpholinocarbonitrile, wherein in particular, N-acetyl-caprolactam and 4-morpholinocarbonitrile, have proved to be particularly effective. The weight fraction of these bleach activators in the total weight of the cleaning agent A is advantageously 0.1 to 25 wt %, preferably 0.5 to 20 wt % and particularly 1.0 to 15 wt %.

In summary, due to their good cleaning and bleaching power, preferred automatic dishwasher detergents according to the invention are those wherein the cleaning agent A comprises bleach activator from the group N-acetyl-caprolactam and 4-morpholinocarbonitrile, advantageously in amounts of 0.1 to 25 wt %, preferably 0.5 to 20 wt % and particularly 1.0 to 15 wt %.

The compositions of some preferred inventive automatic dishwasher detergents can be found in the following Tables:

TABLE 6

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Builder | 10 to 55 | 10 to 45 | 15 to 40 | 20 to 30 |
| Enzyme preparation² | 0.2 to 12 | 0.2 to 12 | 0.5 to 10 | 2.0 to 8.0 |
| Bleach activator³ | 0.01 to 25 | 0.5 to 20 | 0.5 to 20 | 1.0 to 15 |
| Water | 20 to 70 | 22 to 60 | 24 to 55 | 26 to 50 |

Cleaning agent B; pH (20° C.) 4.0 to 7.0

| | | | | |
|---|---|---|---|---|
| Oxygen bleaching agent | 0.2 to 40 | 1.0 to 30 | 1.0 to 30 | 2.0 to 20 |
| Water | 50 to 99 | 60 to 98 | 60 to 98 | 70 to 97 |

TABLE 7

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Potassium | 5.0 to 40 | 5.0 to 40 | 7.0 to 35 | 10 to 30 |
| tripolyphosphate | | | | |
| Phosphonate | 0.8 to 12 | 0.8 to 12 | 1.0 to 10 | 1.2 to 8.0 |
| Sulfopolymer¹ | 0.1 to 15 | 0.1 to 15 | 1.0 to 12 | 2.0 to 10 |
| Enzyme preparation² | 0.2 to 12 | 0.2 to 12 | 0.5 to 10 | 2.0 to 8.0 |
| Bleach activator³ | 0.1 to 25 | 0.5 to 20 | 0.5 to 20 | 1.0 to 15 |
| Water | 20 to 70 | 22 to 60 | 24 to 55 | 26 to 50 |

Cleaning agent B; pH (20° C.) 4.0 to 7.0

| | | | | |
|---|---|---|---|---|
| Oxygen bleaching agent | 0.2 to 40 | 1.0 to 30 | 1.0 to 30 | 2.0 to 20 |
| Water | 50 to 99 | 60 to 98 | 60 to 98 | 70 to 97 |

¹Copolymer, containing i) carboxylic acid group-containing monomer(s), sulfonic acid group-containing monomer(s) and non-ionic monomer(s)
²Amylase, protease or amylase, protease and lipase
³N-Acetyl-caprolactam and/or 4-morpholinocarbonitrile

The cleaning agent A preferably comprises no bleaching agent.

The water content of the cleaning agent A is advantageously 22 to 60 wt %, preferably 24 to 55 wt % and particularly 26 to 50 wt %, each relative to the total weight of the cleaning agent A.

Another preferred ingredient of the inventive cleaning agent A are finally non-ionic surfactants wherein non-ionic surfactants of the general Formula R¹—CH(OH)CH₂O—(AO)_{w}-(A′O)ₓ-(A″O)_{y}-(A′″O)_{z}—R² are preferred, in which
R¹ stands for a straight chain or branched, saturated or mono or polyunsaturated C₆₋₂₄ alkyl or alkenyl group;
R² stands for a linear or branched hydrocarbon group containing 2 to 26 carbon atoms;
A, A′, A″ and A′″ independently of one another stand for a group from the group CH₂CH₂, —CH₂CH₂—CH₂, —CH₂CH(CH₃), —CH₂—CH₂—CH₂—CH₂, —CH₂—CH(CH₃)—CH₂—, —CH₂—CH(CH₂—CH₃),
w, x, y and z stand for values between 0.5 and 120, wherein x, y and/or z can also be 0.

In regard to the aimed for improvement in the cleaning power, as well as the rinsing power, these surfactants have proved to be advantageous.

The stability of the enzymes contained in the cleaning agents A according to the invention can be significantly improved by using these non-ionic surfactants that have one or more free hydroxyl groups on one or both terminal alkyl groups.

Such end capped polyoxyalkylated non-ionic surfactants are particularly preferred that, in accordance with the formula R¹O[CH₂CH₂O]ₓCH₂CH(OH)R², possess, in addition to a group R¹ that stands for linear or branched, saturated or unsaturated, aliphatic or aromatic hydrocarbon groups containing 2 to 30 carbon atoms, preferably containing 4 to 22 carbon atoms, a further linear or branched, saturated or unsaturated, aliphatic or aromatic hydrocarbon group R² containing 1 to 30 carbon atoms, wherein x stands for values between 1 and 90, preferably for values between 30 and 80 and especially for values between 30 and 60.

Particularly preferred are surfactants that satisfy the formula R¹O[CH₂CH(CH₃)O]ₓ[CH₂CH₂O]_{y}CH₂CH(OH)R², in which R¹ stands for a linear or branched aliphatic hydrocarbon group containing 4 to 18 carbon atoms or mixtures thereof, R² means a linear or branched hydrocarbon group containing 2 to 26 carbon atoms or mixtures thereof and x stands for values between 0.5 and 1.5 and y stands for a value of at least 15.

The group of these non-ionic surfactants includes for example the C₂₋₂₆ fatty alcohol-(PO)₁-(EO)₁₅₋₄₀-2-hydroxyalkyl ether, in particular also the C₈₋₁₀ fatty alcohol-(PO)₁-(EO)₂₂-2-hydroxydecyl ether.

Further particularly preferred are those end-capped poly(oxyalkylated) non-ionic surfactants of the formula R¹O[CH₂CH₂O]ₓ[CH₂CH(R³)O]_{y}CH₂CH(OH)R², in which R¹ and R² independently of one another stand for linear or branched, saturated or mono or polyunsaturated hydrocarbon groups containing 2 to 26 carbon atoms, R³ independently of one other is selected from —CH₃, —CH₂CH₃, —CH₂CH₂—CH₃, —CH(CH₃)₂, preferably however —CH₃, and x and y independently of one another stand for values between 1 and 32, wherein surfactants with R³═—CH₃ and values for x of 15 to 32 and y of 0.5 and 1.5 are quite particularly preferred.

Further preferred suitable non-ionic surfactants are the end-blocked poly(oxyalkylated) non-ionic surfactants of the formula R¹O[CH₂CH(R³)O]ₓ[CH₂]ₖCH(OH)[CH₂]ⱼOR², in which R¹ and R² stand for linear or branched, saturated or unsaturated, aliphatic or aromatic hydrocarbon groups containing 1 to 30 carbon atoms, R³ stands for H or for a methyl, ethyl, n-propyl, isopropyl, n-butyl, 2-butyl or 2-methyl-2-butyl group, x for values between 1 and 30, k and j have values between 1 and 12, preferably between 1 and 5. Each R³ in the above formula R¹O[CH₂CH(R³)O]ₓ[CH₂]ₖCH(OH)[CH₂]ⱼOR² can be different for the case where x≧2. R¹ and R² are preferably linear or branched, saturated or unsaturated, aliphatic or aromatic hydrocarbon groups containing 6 to 22 carbon atoms, groups containing 8 to 18 carbon atoms being particularly preferred. H, —CH₃ or —CH₂CH₃ are particularly preferred for the group R³. Particularly preferred values for x are in the range from 1 to 20 and more particularly in the range from 6 to 15.

As described above, each R³ in the above formula can be different for the case where x≧2. By this means, the alkylene oxide unit in the straight brackets can be varied. If, for example, x has a value of 3, then the substituent R³ may be selected to form ethylene oxide (R³═H) or propylene oxide (R³═CH₃) units which may be joined together in any order, for example (EO)(PO)(EO), (EO)(EO)(PO), (EO)(EO)(EO), (PO)(EO)(PO), (PO)(PO)(EO) and (PO)(PO)(PO). The value 3 for x was selected by way of example and may easily be larger, the range of variation increasing with increasing x-values and including, for example, a large number of (EO) groups combined with a small number of (PO) groups or vice versa.

Particularly preferred end-capped poly(oxyalkylated) alcohols corresponding to the above formula have values of k=1 and j=1, so that the above formula can be simplified to R¹O[CH₂CH(R³)O]ₓCH₂CH(OH)CH₂OR². In this last formula, R¹, R² and R³ are as defined above and x stands for numbers from 1 to 30, preferably 1 to 20 and especially 6 to 18. Surfactants in which the substituents R¹ and R² have 9 to 14 carbon atoms, R³ stands for II and x assumes values of 6 to 15 are particularly preferred.

Finally, the non-ionic surfactants of the following general formula R¹—CH(OH)CH₂O-(AO)_{w}—R² have proved to be particularly effective, in which
R¹ stands for a straight chain or branched, saturated or mono or polyunsaturated C₆₋₂₄ alkyl or alkenyl group;
R² stands for a linear or branched hydrocarbon group containing 2 to 20 carbon atoms;
A stands for a group from the group CH₂CH₂, —CH₂CH₂—CH₂, —CH₂—CH(CH₃), and
w stands for values between 10 and 120, preferably 10 to 80, particularly 20 to 40

The group of these non-ionic surfactants includes for example the C₄₋₂₂ fatty alcohol-(EO)₁₀₋₈₀-2-hydroxyalkyl ethers, in particular also the C₈₋₁₂ fatty alcohol-(EO)₂₂-2-hydroxydecyl ethers and the C₄₋₂₂ fatty alcohol-(EO)₄₀₋₈₀-2-hydroxyalkyl ethers.

In an alternative embodiment, inventive automatic cleaning agents A comprise a surfactant of the general Formula R¹—CH(OH)CH₂—O(CH₂CH₂O)ₓCH₂CHR(OCH₂CH₂)_{y}O—CH₂CH(OH)—R², in which
R, R¹ and R² independently of each other stand for an alkyl group or alkenyl group containing 6 to 22 carbon atoms;
x and y independently of one another stand for values between 1 and 40

In addition to or alternatively to the above described embodiments, the inventive cleaning agents A comprise a surfactant of the general Formula

R¹—O(CH₂CH₂O)ₓCR³R⁴(OCH₂CH₂)_{y}O—R², in which
R¹ and R² independently of one another stand for an alkyl group or alkenyl group containing 4 to 22 carbon atoms;
R³ and R⁴ independently of one another stand for H or an alkyl group or alkenyl group containing 1 to 18 carbon atoms and
x and y independently of one another stand for values between 1 and 40;

With regard to its rinse action, in particular when combined with the sulfonic acid group-containing polymers described further above, a non-ionic surfactant of the general Formula R₁—O—(CH₂CH₂O)ₙ—R₃—(OCH₂CH₂)ₘ—O—R₂ is particularly preferred, in which R₁ and R₂ stand for 2-hydroxydecyl ether and R₃ for —CH(C₆H₁₃)—CH₂— or —CH(C₈H₁₇)—CH₂— and n+m for at least 15.

10093] The weight fraction of the non-ionic surfactant in the total weight of the cleaning agent A is advantageously 0.1 to 20 wt %, preferably 0.5 to 15 wt %, particularly preferably 1.0 to 12 wt % and especially 2.0 to 8 wt %.

The compositions of some preferred inventive automatic dishwasher detergents can be found in the following Tables:

TABLE 8

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Builder | 10 to 55 | 10 to 45 | 15 to 40 | 20 to 30 |
| Enzyme preparation² | 0.2 to 12 | 0.2 to 12 | 0.5 to 10 | 2.0 to 8.0 |
| Bleach activator³ | 0.01 to 25 | 0.5 to 20 | 0.5 to 20 | 1.0 to 15 |
| Non-ionic surfactant | 0.01 to 20 | 0.5 to 15 | 1.0 to 12 | 2.0 to 8.0 |
| Water | 20 to 70 | 22 to 60 | 24 to 55 | 26 to 50 |

Cleaning agent B; pH (20° C.) 4.0 to 7.0

| | | | | |
|---|---|---|---|---|
| Oxygen bleaching agent | 0.2 to 40 | 1.0 to 30 | 1.0 to 30 | 2.0 to 20 |
| Water | 50 to 99 | 60 to 98 | 60 to 98 | 70 to 97 |

TABLE 9

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Potassium | 5.0 to 40 | 5.0 to 40 | 7.0 to 35 | 10 to 30 |
| tripolyphosphate | | | | |
| Phosphonate | 0.8 to 12 | 0.8 to 12 | 1.0 to 10 | 1.2 to 8.0 |
| Sulfopolymer¹ | 0.1 to 15 | 0.1 to 15 | 1.0 to 12 | 2.0 to 10 |
| Enzyme preparation² | 0.2 to 12 | 0.2 to 12 | 0.5 to 10 | 2.0 to 8.0 |
| Bleach activator³ | 0.1 to 25 | 0.5 to 20 | 0.5 to 20 | 1.0 to 15 |
| Non-ionic surfactant | 0.01 to 20 | 0.5 to 15 | 1.0 to 12 | 2.0 to 8.0 |
| Water | 20 to 70 | 22 to 60 | 24 to 55 | 26 to 50 |

Cleaning agent B; pH (20° C.) 4.0 to 7.0

| | | | | |
|---|---|---|---|---|
| Oxygen bleaching agent | 0.2 to 40 | 1.0 to 30 | 1.0 to 30 | 2.0 to 20 |
| Water | 50 to 99 | 60 to 98 | 60 to 98 | 70 to 97 |

¹Copolymer, containing i) carboxylic acid group-containing monomer(s), sulfonic acid group-containing monomer(s) and non-ionic monomer(s)
²Amylase, protease or amylase, protease and lipase
³N-Acetyl-caprolactam and/or 4-morpholinocarbonitrile

The cleaning agent B comprises 0.1 to 50 wt % oxygen bleaching agent as an essential ingredient in addition to the solvent water. Inorganic peroxy compounds are preferred, although in principal organic peroxy compounds, especially peroxycarboxylic acids, such as for example peracetic acid, are also suitable. Imidopercarboxylic acids, particularly phthalimidopercarboxylic acids and especially the phthalimidoperhexanoic acid (PAP) may also be cited as the preferred percarboxylic acids. Salts of the persulfuric acids, especially peroxymonosulfate and peroxydisulfate salts, can be considered as exemplary inorganic peroxy compounds, however hydrogen peroxide and those compounds that release hydrogen peroxide in aqueous solution are of particular interest. Examples of such compounds that release hydrogen peroxide are especially the perborates, primarily sodium perborate monohydrate and sodium perborate tetrahydrate, as well as addition compounds of hydrogen peroxide onto inorganic compounds, especially the addition compound of sodium carbonate and hydrogen peroxide, also known as percarbonate, as well as optionally also addition compounds of hydrogen peroxide onto organic compounds, for example urea or sodium citrate. Hydrogen peroxide as well as the perborates and sodium percarbonate are particularly preferred. The added quantity of the oxidizing agent depends on its active oxygen content, which again depends on the molecular weight of the oxidizing agent. The active oxygen content in hydrogen peroxide is for example therefore 47%, whereas that of sodium perborate tetrahydrate is 10 4%.

The use of hydrogen peroxide as the oxygen bleaching agent is particularly preferred.

Automatic dishwasher detergents according to the invention, wherein the cleaning agent B comprises hydrogen peroxide as the oxygen bleaching agent, preferably in amounts of 0.2 to 40 wt %, preferably 1.0 to 30 wt % and particularly 2.0 to 20 wt %, each relative to the total weight of the cleaning agent B, are preferred.

The compositions of some preferred inventive automatic dishwasher detergents can be found in the following Tables:

TABLE 10

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Builder | 10 to 55 | 10 to 45 | 15 to 40 | 20 to 30 |
| Enzyme preparation² | 0.2 to 12 | 0.2 to 12 | 0.5 to 10 | 2.0 to 8.0 |
| Bleach activator³ | 0.01 to 3.0 | 0.01 to 2.0 | 0.01 to 1.0 | 0.01 to 1.0 |
| Water | 20 to 70 | 22 to 60 | 24 to 55 | 26 to 50 |

Cleaning agent B; pH (20° C.) 4.0 to 7.0

| | | | | |
|---|---|---|---|---|
| Hydrogen peroxide | 0.2 to 40 | 1.0 to 30 | 1.0 to 30 | 2.0 to 20 |
| Water | 50 to 99 | 60 to 98 | 60 to 98 | 70 to 97 |

TABLE 11

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Potassium | 5.0 to 40 | 5.0 to 40 | 7.0 to 35 | 10 to 30 |
| tripolyphosphate | | | | |
| Phosphonate | 0.8 to 12 | 0.8 to 12 | 1.0 to 10 | 1.2 to 8.0 |
| Sulfopolymer¹ | 0.1 to 15 | 0.1 to 15 | 1.0 to 12 | 2.0 to 10 |
| Enzyme preparation² | 0.2 to 12 | 0.2 to 12 | 0.5 to 10 | 2.0 to 8.0 |
| Bleach activator³ | 0.01 to 3.0 | 0.01 to 2.0 | 0.01 to 1.0 | 0.01 to 1.0 |
| Water | 20 to 70 | 22 to 60 | 24 to 55 | 26 to 50 |

Cleaning agent B; pH (20° C.) 4.0 to 7.0

| | | | | |
|---|---|---|---|---|
| Hydrogen peroxide | 0.2 to 40 | 1.0 to 30 | 1.0 to 30 | 2.0 to 20 |
| Water | 50 to 99 | 60 to 98 | 60 to 98 | 70 to 97 |

TABLE 12

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Builder | 10 to 55 | 10 to 45 | 15 to 40 | 20 to 30 |
| Enzyme preparation² | 0.2 to 12 | 0.2 to 12 | 0.5 to 10 | 2.0 to 8.0 |
| Bleach activator⁴ | 0.1 to 25 | 0.5 to 20 | 0.5 to 20 | 1.0 to 15 |
| Water | 20 to 70 | 22 to 60 | 24 to 55 | 26 to 50 |

Cleaning agent B; pH (20° C.) 4.0 to 7.0

| | | | | |
|---|---|---|---|---|
| Hydrogen peroxide | 0.2 to 40 | 1.0 to 30 | 1.0 to 30 | 2.0 to 20 |
| Water | 50 to 99 | 60 to 98 | 60 to 98 | 70 to 97 |

TABLE 13

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Potassium | 5.0 to 40 | 5.0 to 40 | 7.0 to 35 | 10 to 30 |
| tripolyphosphate | | | | |
| Phosphonate | 0.8 to 12 | 0.8 to 12 | 1.0 to 10 | 1.2 to 8.0 |
| Sulfopolymer¹ | 0.1 to 15 | 0.1 to 15 | 1.0 to 12 | 2.0 to 10 |
| Enzyme preparation² | 0.2 to 12 | 0.2 to 12 | 0.5 to 10 | 2.0 to 8.0 |
| Bleach activator⁴ | 0.1 to 25 | 0.5 to 20 | 0.5 to 20 | 1.0 to 15 |
| Water | 20 to 70 | 22 to 60 | 24 to 55 | 26 to 50 |

Cleaning agent B; pH (20° C.) 4.0 to 7.0

| | | | | |
|---|---|---|---|---|
| Hydrogen peroxide | 0.2 to 40 | 1.0 to 30 | 1.0 to 30 | 2.0 to 20 |
| Water | 50 to 99 | 60 to 98 | 60 to 98 | 70 to 97 |

¹Copolymer, containing i) carboxylic acid group-containing monomer(s), sulfonic acid group-containing monomer(s) and non-ionic monomer(s)
²Amylase, protease or amylase, protease and lipase
³Transition metal catalyst of manganese
⁴N-Acetyl-caprolactam and/or 4-morpholinocarbonitrile

The number of the active cleaning active substances comprised in the cleaning agent B is preferably limited to not more than 5, preferably not more than 4 and especially not more than 3 In regard to the cleaning power of the inventive automatic dishwasher detergent, preferred active substances incorporated in the cleaning agent B are the phosphonates already described further above. The weight fraction of these phosphonates in the total weight of the cleaning agent B is advantageously 0.01 to 8.0 wt %, preferably 0.1 to 6 wt % and particularly 0.2 to 4.0 wt %.

Inventively preferred cleaning agents B comprise, relative to their total weight, and besides water and oxygen bleaching agent, less than 20 wt %, preferably less than 15 wt % and especially less than 10 wt % of further ingredients. Particularly preferred inventive cleaning agents B comprise maximum 8.0 wt %, preferably maximum 4.0 wt %, particularly preferably maximum 2.0 wt % and particularly maximum 1.0 wt % of additional ingredients. In particular, the cleaning agent B advantageously comprises no enzyme.

The water content of the cleaning agent B is advantageously 55 to 99 wt %, preferably 60 to 98 wt % and particularly 70 to 97 wt %, each relative to the total weight of the cleaning agent B.

The compositions of some preferred inventive automatic dishwasher detergents can be found in the following Tables:

TABLE 14

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Builder | 10 to 55 | 10 to 45 | 15 to 40 | 20 to 30 |
| Enzyme preparation² | 0.2 to 12 | 0.2 to 12 | 0.5 to 10 | 2.0 to 8.0 |
| Bleach activator³ | 0.01 to 3.0 | 0.01 to 2.0 | 0.01 to 1.0 | 0.01 to 1.0 |
| Water | 20 to 70 | 22 to 60 | 24 to 55 | 26 to 50 |
| Bleaching agent | — | — | — | — |

Cleaning agent B; pH (20° C.) 4.0 to 7.0

| | | | | |
|---|---|---|---|---|
| Hydrogen peroxide | 0.2 to 40 | 1.0 to 30 | 1.0 to 30 | 2.0 to 20 |
| Phosphonate | 0.01 to 8.0 | 0.01 to 8.0 | 0.1 to 6.0 | 0.2 to 4.0 |
| Water | 50 to 99 | 60 to 98 | 60 to 98 | 70 to 97 |
| Remainder | ≦8.0 | ≦4.0 | ≦2.0 | ≦1.0 |
| Enzymes | — | — | — | — |

TABLE 15

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Potassium | 5.0 to 40 | 5.0 to 40 | 7.0 to 35 | 10 to 30 |
| tripolyphosphate | | | | |
| Phosphonate | 0.8 to 12 | 0.8 to 12 | 1.0 to 10 | 1.2 to 8.0 |
| Sulfopolymer¹ | 0.1 to 15 | 0.1 to 15 | 1.0 to 12 | 2.0 to 10 |
| Enzyme preparation² | 0.2 to 12 | 0.2 to 12 | 0.5 to 10 | 2.0 to 8.0 |
| Bleach activator³ | 0.01 to 3.0 | 0.01 to 2.0 | 0.01 to 1.0 | 0.01 to 1.0 |
| Water | 20 to 70 | 22 to 60 | 24 to 55 | 26 to 50 |
| Bleaching agent | — | — | — | — |

Cleaning agent B; pH (20° C.) 4.0 to 7.0

| | | | | |
|---|---|---|---|---|
| Hydrogen peroxide | 0.2 to 40 | 1.0 to 30 | 1.0 to 30 | 2.0 to 20 |
| Phosphonate | 0.01 to 8.0 | 0.01 to 8.0 | 0.1 to 6.0 | 0.2 to 4.0 |
| Water | 50 to 99 | 60 to 98 | 60 to 98 | 70 to 97 |
| Remainder | ≦8.0 | ≦4.0 | ≦2.0 | ≦1.0 |
| Enzymes | — | — | — | — |

TABLE 16

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Potassium | 5.0 to 40 | 5.0 to 40 | 7.0 to 35 | 10 to 30 |
| tripolyphosphate | | | | |
| Phosphonate | 0.8 to 12 | 0.8 to 12 | 1.0 to 10 | 1.2 to 8.0 |
| Sulfopolymer¹ | 0.1 to 15 | 0.1 to 15 | 1.0 to 12 | 2.0 to 10 |
| Enzyme preparation² | 0.2 to 12 | 0.2 to 12 | 0.5 to 10 | 2.0 to 8.0 |
| Bleach activator³ | 0.01 to 3.0 | 0.01 to 2.0 | 0.01 to 1.0 | 0.01 to 1.0 |
| Non-ionic surfactant | 0.1 to 20 | 0.5 to 15 | 1.0 to 12 | 2.0 to 8.0 |
| Water | 20 to 70 | 22 to 60 | 24 to 55 | 26 to 50 |
| Bleaching agent | — | — | — | — |

Cleaning agent B; pH (20° C.) 4.0 to 7.0

| | | | | |
|---|---|---|---|---|
| Hydrogen peroxide | 0.2 to 40 | 1.0 to 30 | 1.0 to 30 | 2.0 to 20 |
| Phosphonate | 0.01 to 8.0 | 0.01 to 8.0 | 0.1 to 6.0 | 0.2 to 4.0 |
| Water | 50 to 99 | 60 to 98 | 60 to 98 | 70 to 97 |
| Remainder | ≦8.0 | ≦4.0 | ≦2.0 | ≦1.0 |
| Enzymes | — | — | — | — |

TABLE 17

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Builder | 10 to 55 | 10 to 45 | 15 to 40 | 20 to 30 |
| Enzyme preparation² | 0.2 to 12 | 0.2 to 12 | 0.5 to 10 | 2.0 to 8.0 |
| Bleach activator⁴ | 0.1 to 25 | 0.5 to 20 | 0.5 to 20 | 1. to 15 |
| Water | 20 to 70 | 22 to 60 | 24 to 55 | 26 to 50 |
| Bleaching agent | — | — | — | — |

Cleaning agent B; pH (20° C.) 4.0 to 7.0

| | | | | |
|---|---|---|---|---|
| Hydrogen peroxide | 0.2 to 40 | 1.0 to 30 | 1.0 to 30 | 2.0 to 20 |
| Phosphonate | 0.01 to 8.0 | 0.01 to 8.0 | 0.1 to 6.0 | 0.2 to 4.0 |
| Water | 50 to 99 | 60 to 98 | 60 to 98 | 70 to 97 |
| Remainder | ≦8.0 | ≦4.0 | ≦2.0 | ≦1.0 |
| Enzymes | — | — | — | — |

TABLE 18

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Potassium | 5.0 to 40 | 5.0 to 40 | 7.0 to 35 | 10 to 30 |
| tripolyphosphate | | | | |
| Phosphonate | 0.8 to 12 | 0.8 to 12 | 1.0 to 10 | 1.2 to 8.0 |
| Sulfopolymer¹ | 0.1 to 15 | 0.1 to 15 | 1.0 to 12 | 2.0 to 10 |
| Enzyme preparation² | 0.2 to 12 | 0.2 to 12 | 0.5 to 10 | 2.0 to 8.0 |
| Bleach activator⁴ | 0.1 to 25 | 0.5 to 20 | 0.5 to 20 | 1.0 to 15 |
| Water | 20 to 70 | 22 to 60 | 24 to 55 | 26 to 50 |
| Bleaching agent | — | — | — | — |

Cleaning agent B; pH (20° C.) 4.0 to 7.0

| | | | | |
|---|---|---|---|---|
| Hydrogen peroxide | 0.2 to 40 | 1.0 to 30 | 1.0 to 30 | 2.0 to 20 |
| Phosphonate | 0.01 to 8.0 | 0.01 to 8.0 | 0.1 to 6.0 | 0.2 to 4.0 |
| Water | 50 to 99 | 60 to 98 | 60 to 98 | 70 to 97 |
| Remainder | ≦8.0 | ≦4.0 | ≦2.0 | ≦1.0 |
| Enzymes | — | — | — | — |

TABLE 19

| | | | |
|---|---|---|---|
| Form. 1 | Form. 2 | Form. 3 | Form. 4 |
| [wt %] | [wt %] | [wt %] | [wt %] |

Cleaning agent A; pH (20° C.) 6.5 to 8.5

| | | | | |
|---|---|---|---|---|
| Potassium | 5.0 to 40 | 5.0 to 40 | 7.0 to 35 | 10 to 30 |
| tripolyphosphate | | | | |
| Phosphonate | 0.8 to 12 | 0.8 to 12 | 1.0 to 10 | 1.2 to 8.0 |
| Sulfopolymer¹ | 0.1 to 15 | 0.1 to 15 | 1.0 to 12 | 2.0 to 10 |
| Enzyme preparation² | 0.2 to 12 | 0.2 to 12 | 0.5 to 10 | 2.0 to 8.0 |
| Bleach activator⁴ | 0.1 to 25 | 0.5 to 20 | 0.5 to 20 | 1.0 to 15 |
| Non-ionic surfactant | 0.1 to 20 | 0.5 to 15 | 1.0 to 12 | 2.0 to 8.0 |
| Water | 20 to 70 | 22 to 60 | 24 to 55 | 26 to 50 |
| Bleaching agent | — | — | — | — |

Cleaning agent B; pH (20° C.) 4.0 to 7.0

| | | | | |
|---|---|---|---|---|
| Hydrogen peroxide | 0.2 to 40 | 1.0 to 30 | 1.0 to 30 | 2.0 to 20 |
| Phosphonate | 0.01 to 8.0 | 0.01 to 8.0 | 0.1 to 6.0 | 0.2 to 4.0 |
| Water | 50 to 99 | 60 to 98 | 60 to 98 | 70 to 97 |
| Remainder | ≦8.0 | ≦4.0 | ≦2.0 | ≦1.0 |
| Enzymes | — | — | — | — |

¹Copolymer, containing i) carboxylic acid group-containing monomer(s), sulfonic acid group-containing monomer(s) and non-ionic monomer(s)
²Amylase, protease or amylase, protease and lipase
³Transition metal catalyst of manganese
⁴N-Acetyl-caprolactam and/or 4-morpholinocarbonitrile

The above described combinations of active substances are particularly suitable for cleaning tableware in automatic dishwashing processes. Another subject matter of the present application is a process for cleaning tableware in an automatic dishwasher, involving the use of an inventive automatic dishwasher detergent, wherein the automatic dishwasher detergents are preferably metered into the interior of an automatic dishwasher during the course of a dishwashing program, prior to the start of the main wash cycle or in the course of the main wash cycle. The inventive agent can be manually entered or metered into the interior of the automatic dishwasher, but the agent is preferably metered into the interior of the automatic dishwasher by means of the metering chamber of the automatic dishwasher. Preferably, no additional water softener and no additional rinse agent is metered into the interior of the automatic dishwasher in the course of the cleaning process. A kit for an automatic dishwasher, containing
a) an inventive automatic dishwasher detergent;
b) directions for use, which inform the consumer not to use any additional rinse aid and/or water softening salt with the automatic dishwasher detergent,
   is another subject matter of this application.

The inventive automatic dishwasher detergents also show their advantageous cleaning properties particularly in low temperature cleaning processes.

Consequently, preferred dishwashing processes involving the use of the inventive agent are those wherein the dishwasher process is carried out with a liquor temperature below 60° C., preferably below 50° C.

The inventive automatic dishwasher detergents also show their advantageous cleaning properties particularly in short washing programs. Consequently, preferred dishwashing processes involving the use of the inventive agent are those wherein the time for the dishwasher processes does not exceed 70 minutes, preferably 60 minutes and particularly 45 minutes.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An automatic dishwasher detergent, including a packaging means, in which are located two separately packaged liquid cleaning agents A and B of the composition comprising:
A. 10 to 55 wt % builder(s);
0.1 to 15 wt % enzyme preparation(s);
0.001 to 30 wt % bleach activator
20 to 70 wt % water; and
B. 50 to 99.9 wt % water;
0.1 to 50 wt % oxygen bleaching agent
less than 20 wt % of other ingredients
wherein the liquid cleaning agents A and B exhibit a pH (20° C.) below 9.

2. The automatic dishwasher detergent according to claim 1, wherein the cleaning agent A comprises calcium-complexing builders in amounts of 10 to 45 wt % relative to the total weight of the cleaning agent A.

3. The automatic dishwasher detergent according to claim 1, wherein the cleaning agent A comprises enzymes from the group of the amylases, proteases and/or lipases in amounts of 0.2 to 12 wt % relative to the total weight of the cleaning agent A.

4. The automatic dishwasher detergent according to claim 1, wherein the cleaning agent A comprises bleach activator from the group of the transition metal catalysts of manganese in amounts of 0.01 to 3.0 wt % relative to the total weight of the cleaning agent A.

5. The automatic dishwasher detergent according to claim 1, wherein the cleaning agent A comprises bleach activator from the group N-acetyl-caprolactam and 4-morpholinocarbonitrile in amounts of 0.1 to 25 wt %.

6. The automatic dishwasher detergent according to claim 1, wherein the cleaning agent B comprises hydrogen peroxide as the oxygen bleaching agent in amounts of 0.2 to 40 wt % relative to the total weight of the cleaning agent B.

7. The automatic dishwasher detergent according to claim 1, wherein the cleaning agent B, relative to its total weight, comprises, exclusive of water and oxygen bleaching agent, a maximum 8.0 wt % of additional ingredients.

8. The automatic dishwasher detergent according to claim 1, wherein the cleaning agent A exhibits a pH value (20° C.) between 6.5 and 8.5.
